(19) United States
(12) Patent Application Publication
(10) Pub. No.: US 2024/0345863 A1
(43) Pub. Date: Oct. 17, 2024

(54) HYPERVISOR-BASED MONITORING OF SAMPLES EXECUTING IN A VIRTUAL MACHINE VIA AMSI INTERCEPTION

(71) Applicant: Palo Alto Networks, Inc., Santa Clara, CA (US)

(72) Inventors: Michael Sean Hughes, Davenport, FL (US); Esmid Idrizovic, Trumau (AT); Robert Alphonse Jung, Albuquerque, NM (US); Saqib Ahmed Khanzada, Friedrichshafen (DE)

(21) Appl. No.: 18/347,764

(22) Filed: Jul. 6, 2023

Related U.S. Application Data
(60) Provisional application No. 63/496,469, filed on Apr. 17, 2023.

(51) Int. Cl. G06F 9/455; G06F 21/56

(52) U.S. Cl. CPC G06F 9/45558; G06F 21/566; G06F 2009/45587

(57) ABSTRACT

A hypervisor-based service monitors antimalware scan interface (AMSI) events triggered from inside a virtual machine (VM) to analyze behavior of software samples. A sample is loaded into a VM for execution by an AMSI-enabled application/service of the VM. The monitoring service can register a dummy AMSI provider for the VM, which enables the AMSI for compatible applications/services of the VM upon registration but does not implement buffer scanning or analysis. The monitoring service hooks into at least a first function of the AMSI by which buffers are submitted for a malware scan. Upon invocation of the function from inside the VM, the monitoring service intercepts the buffer submission and analyzes the buffer based on criteria for detecting an AMSI bypass attempt. If at least a first AMSI bypass detection criterion is satisfied, the monitoring service blocks the attempted AMSI bypass and continues monitoring execution of the sample.

### BACKGROUND

The disclosure generally relates to data processing (e.g., CPC subclass G06F) and to security arrangements for protecting computers, components thereof, programs or data against unauthorized activity (e.g., CPC subclass G06F 21/00).

The Windows® Antimalware Scan Interface (AMSI) is an interface that provides for integration of antimalware software installed on a computing device and the Windows services and components into which the AMSI functionality is incorporated. AMSI comprises an open application programming interface (API) and is thus compatible with Windows antimalware products and services as well as third-party antimalware software. Invocation of the AMSI API by antimalware software allows the antimalware software to scan or otherwise analyze program code, including macros and scripts, for malware prior to execution. Antimalware software can utilize the functionality made available by AMSI by registering as an AMSI provider through registration of a dynamic link library (DLL) file that implements the IAntimalwareProvider interface used by AMSI.

Virtual machine introspection (VMI) is a technique by which software executing in a virtual machine can be analyzed through monitoring the virtual machine from the outside rather than from the inside, such as by an agent loaded in the virtual machine. In other words, in systems where a hypervisor (also referred to as a virtual machine monitor (VMM)) has been installed, VMI-based monitoring functionality can be implemented as part of the hypervisor to monitor the hardware state, such as physical memory pages and interrupts, of a virtual machine in which software of interest has been loaded. Because of the lack of presence inside the virtual machine and resulting ability to go undetected by the software executing therein, VMI is often utilized for analysis of malware that potentially employs detection evasion techniques.

### BRIEF DESCRIPTION OF THE DRAWINGS

Embodiments of the disclosure may be better understood by referencing the accompanying drawings.

FIG. 1 is a conceptual diagram of hypervisor-based monitoring of AMSI events triggered from inside a virtual machine.

FIG. 2 is a flowchart of example operations for instrumenting the AMSI for interception of submission of content via the AMSI by the hypervisor.

FIG. 3 is a flowchart of example operations for analyzing behavior of a sample executing in a virtual machine based on a buffer(s) received by the hypervisor via the AMSI.

FIG. 4 depicts an example computer system with a hypervisor-based AMSI event monitoring service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

When AMSI is employed for malware detection of software samples (e.g., program code detected or identified from network traffic) loaded into a virtual machine, such as through sandboxing, the AMSI provider is loaded into the virtual machine for execution alongside the program code subject to monitoring. Due to the widespread use of AMSI and known techniques for its implementation, however, program code that employs detection evasion techniques can detect the presence of the AMSI provider in the virtual machine and consequently evade detection by the antimalware software that is registered as the AMSI provider, referred to as AMSI bypass.

A hypervisor-based monitoring service monitors AMSI events triggered from inside a virtual machine to analyze behavior of software samples (hereinafter “samples”), including to detect AMSI bypass attempts, as disclosed herein. A sample that is subject to monitoring is loaded into a virtual machine for execution by an AMSI-enabled application or service of the virtual machine. Examples of samples that can be monitored include malicious scripts, files, macros, etc., and the monitored samples may employ obfuscation to hinder detection as being malicious. The monitoring service can register a dummy AMSI provider for the virtual machine, where the dummy AMSI provider provides for AMSI to be enabled for compatible applications/services of the virtual machine upon registration but does not implement buffer scanning or analysis. The monitoring service hooks into a function of the AMSI invoked by applications/services to submit a buffer comprising data to be scanned for malware to the AMSI provider (“buffer submission function call”). Upon invocation of the hooked AMSI function from inside the virtual machine, the monitoring service intercepts the buffer submission function call to obtain an indication of the buffer and the data included therein outside of the virtual machine so that the data can be analyzed by the hypervisor. The monitoring service analyzes the data stored in the buffer based on one or more detection criteria that at least includes one or more criteria for detecting an AMSI bypass attempt. If an AMSI bypass detection criterion is satisfied, the monitoring service can block the attempted AMSI bypass; blocking the attempted bypass is possible due to the AMSI event monitoring being part of the hypervisor rather than occurring within the virtual machine. The monitoring service can continue monitoring execution of the sample through interception of buffer submissions in this manner until execution of the sample terminates. Malware analysis of the data submitted via the AMSI during execution of the sample can then be performed by the hypervisor or by an external service. Because any AMSI bypass attempts were blocked and execution of the sample could resume unhindered, the behavior of the sample can be examined that would otherwise go unobserved as a result of an AMSI bypass, thus providing for more complete malware analysis results.

### Example Illustrations

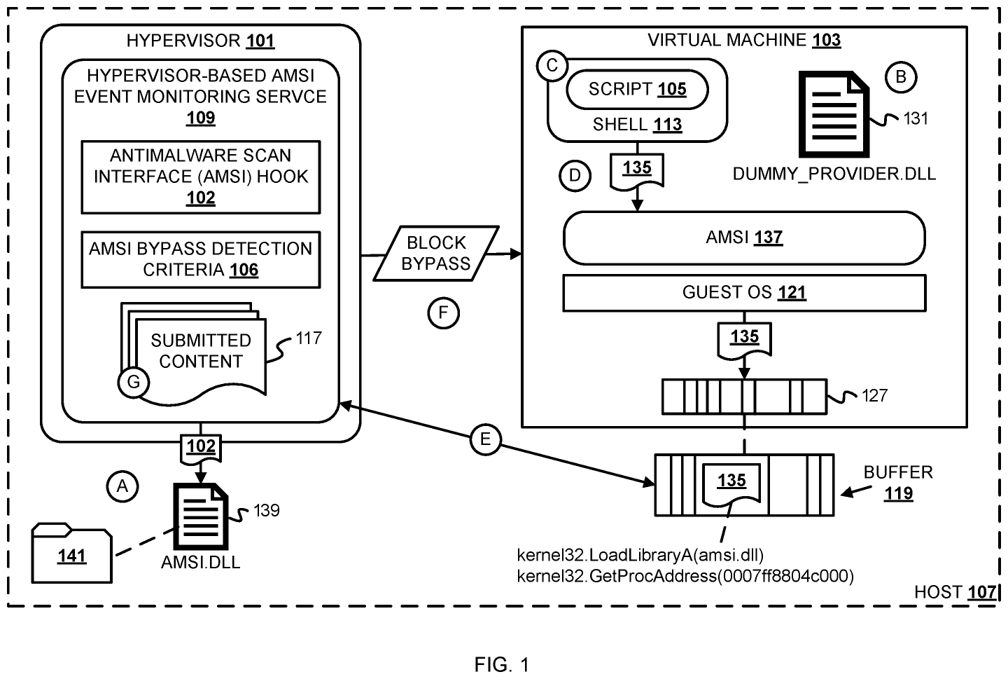

FIG. 1 is a conceptual diagram of hypervisor-based monitoring of AMSI events triggered from inside a virtual machine. A hypervisor 101 runs on a host 107. The hypervisor 101 is depicted as a bare metal hypervisor, though in implementations, hosted hypervisors may be deployed. This example assumes a hypervisor 101 has already created a virtual machine (“the VM”) 103. The VM 103 comprises a guest operating system (OS) 121, which is a Windows OS that has AMSI integration capabilities. A shell 113 (e.g., a command-line shell of PowerShell) runs in the VM 103 in this example. A hypervisor-based AMSI event monitoring service (“the service”) 109 executes as part of the hypervisor 101. The service 109 uses VMI to intercept AMSI function invocations so that analysis of content submitted via the AMSI for malware scanning by an application/service of the VM 103 is performed outside of the VM 103 at the level of the hypervisor 101.

FIG. 1 is annotated with a series of letters A-G. Each of the letters represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the service 109 inserts at least a first AMSI hook 102 into amsi.dll, depicted in FIG. 1 as AMSI DLL 139. “The AMSI” refers to the AMSI functionality implemented with the AMSI DLL 139, which may be stored in a file system 141 of the host 107. The service 109 “hooks into” the AMSI DLL 139 via the AMSI hook 102, which is a code hook that, when triggered, allows the service 109 to intercept submission of a function call to the AMSI by which the callee of the function submits the buffer comprising content to be scanned for malware (i.e., the AmsiScanBuffer function). Interception of this function call by the service 109 allows the service 109 to perform the buffer scan outside of virtual machines that load the AMSI DLL 139 and invoke AMSI functionality during execution of samples being analyzed. To hook into the AMSI, the service 109 can insert a code hook into the AMSI DLL 139 at least at the function AmsiScanBuffer to redirect execution to the service 109 when AmsiScanBuffer is invoked. When the AMSI DLL 139 is loaded, the function AmsiScanBuffer will thus be hooked.

At stage B, the service 109 registers a dummy AMSI provider 131 for the VM 103. Typically, an AMSI provider DLL that implements malware scanning as afforded by the AMSI is registered for a system. The dummy AMSI provider 131, however, is a dummy DLL that does not implement malware scanning or detection logic. The service 109 can register the dummy AMSI provider 131 for the VM 103 by executing a script(s) for DLL registration. Registration of the dummy AMSI provider 131 enables AMSI for the VM 103; in other words, once the dummy AMSI provider 131 is registered, the AMSI DLL 139 can be loaded by applications/services of the VM 103 and AMSI sessions can be established for submission of content for malware scanning. FIG. 1 depicts the VM 103 as comprising AMSI 137, which represents the AMSI functions exposed to the applications/services of the VM 103 after loading the AMSI DLL 139.

At stage C, the service 109 loads a script 105 into the VM 103 for execution by a shell 113 of the VM 103. In implementations, the service 109 can load samples of various types into virtual machines for execution by any appropriate AMSI-compatible application/service. In this example, the sample is a script that is executed by the shell 113 of the VM 103.

At stage D, during execution of the script 105, the shell 113 invokes the hooked function of the AMSI 137, or AmsiScanBuffer, to submit content 135 for malware scanning. The shell 113 may have invoked the function AmsiScanBuffer of the AMSI 137 and provided with the function invocation a pointer to a buffer 119 that stores the content 135. The content 135 can comprise one or more lines of code (e.g., function calls) of which the script 105 is comprised. Memory 127 of the host 107 that has been allocated to the VM 103 comprises the buffer 119. In this example, the content 135 comprises two function calls made by the script 105: kernel32.LoadLibrary A (amsi.dll), and kernel32.GetProcAddress (0007ff8804c000). Rather than an AMSI provider such as the dummy AMSI provider receiving the indication of content 135 to scan, however, the service 109 intercepts the AMSI 137 function invocation as a result of having hooked into the AMSI 137 via the AMSI hook 102. The VM 103 also is paused once the hooked function of the AMSI 137 is invoked and execution redirects to the service 109, which consequently pauses execution of the script 105 (particularly the line(s) of the script 105 comprising the content submitted for scanning via the AMSI 137). The service 109 thus receives the indication of the content 135 and can perform its analysis outside of the VM 103.

At stage E, the service 109 reads the content 135 from the buffer 119 for analysis based on AMSI bypass detection criteria (“the criteria”) 106. The criteria 106 comprise one or more criteria for detecting AMSI bypass attempts based on analyzing content indicated in AMSI 137 function invocations that are intercepted by the service 109. For instance, the criteria 106 may comprise one or more keywords and/or sequences thereof that the service 109 can identify in data submitted for scanning via the AMSI 137. As an example, the criteria 106 may indicate that identifying keywords indicative of function calls to obtain a handle for the AMSI DLL and get an address of the AMSI DLL is indicative of an AMSI bypass attempt.

With reference to this example, the service 109 analyzes the content 135 read from the buffer 119 and evaluates the content 135 based on the criteria 106. Upon identifying keywords that are specified by the criteria 106, (e.g., “LoadLibrary A (amsi.dll)” and “GetProcAddress”), the service 109 determines that the content 135 is indicative of an attempt by the script 105 to bypass the AMSI 137. Due to the semantic gap between the hypervisor 101 and the VM 103 that is inherent to VMI implementations, the criteria 106 can be implemented at a level of abstraction from memory of the host 107 at which AMSI bypasses can be detected based on the data read from the buffer 119. To illustrate, while the example for the criteria 106 of FIG. 1 is at the source code level for ease of understanding, which includes keywords in plain English, in implementations, the criteria 106 including any keywords are not necessarily at a high semantic level (i.e., human language keywords).

At stage F, the service 109 blocks the AMSI 137 bypass attempt by the script 105 and continues monitoring its execution in the VM 103. The service 109 can control execution of the VM 103 by the nature of being incorporated as part of the hypervisor 101. The service 109 may communicate a command to the VM 103 to block execution of a line of the script 105 that triggered the shell 113 to invoke the function of the AMSI 137. Although blocking execution of malicious code is a capability of the AMSI 137, typical use cases terminate execution of the sample upon detecting malicious code. When the service 109 detects an AMSI bypass, however, execution of samples is permitted to resume after the suspected AMSI bypass is blocked.

At stage G, the service 109 stores the content 135 in a set of submitted content 117 that the shell 113 submitted for malware scanning via the AMSI 137 during execution of the script 105. The service 109 can copy the content 135 read from the buffer 119 into the set of submitted content 117 that it maintains until execution of the script 105 has completed. Later (e.g., when the script 105 has finished executing), the service 109 can designate the set of submitted content 117 for additional analysis, such as malware analysis beyond AMSI bypass detection. Designation of the set of submitted content 117 for malware analysis can include providing the set of submitted content 117 to another service of the hypervisor 101 or communicating the set of submitted content 117 to an external service, either of the host 107 or of another, external host, that analyzes content obtained via the AMSI 137 for malware. Malware analysis of the script 105 and observation of its behavior in full thus is not hindered by an AMSI bypass.

FIG. 1 depicts the registration of a dummy AMSI provider to enable AMSI for the VM 103. In implementations, the service 109 can enable AMSI for the VM 103 with other techniques. For instance, the service 109 may hook into one or more functions of the AMSI DLL and/or functions pertaining to AMSI provider registration to enable functionality of the AMSI 137 for the VM 103.

While not depicted in FIG. 1, in implementations, the service 109 may track whether an AMSI bypass detection was detected for samples being analyzed. Upon detecting an AMSI bypass attempt based on satisfaction of one of the criteria 106, the service 109 can indicate that the sample has already attempted to bypass the AMSI 137 (e.g., based on setting a Boolean or other binary value). The service 109 may maintain additional criteria for analysis of other aspects of sample behavior, such as malware detection criteria. Assuming most samples will not perform multiple AMSI bypass attempts, the service 109 can analyze subsequent to detection of a first AMSI bypass attempt content submitted to the AMSI 137 that is intercepted based on the additional criteria to determine behavior of the sample.

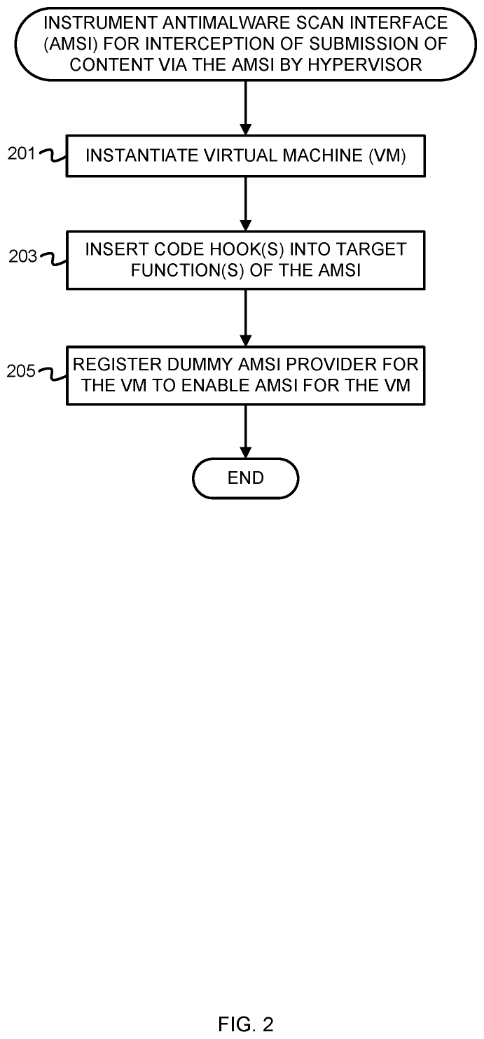

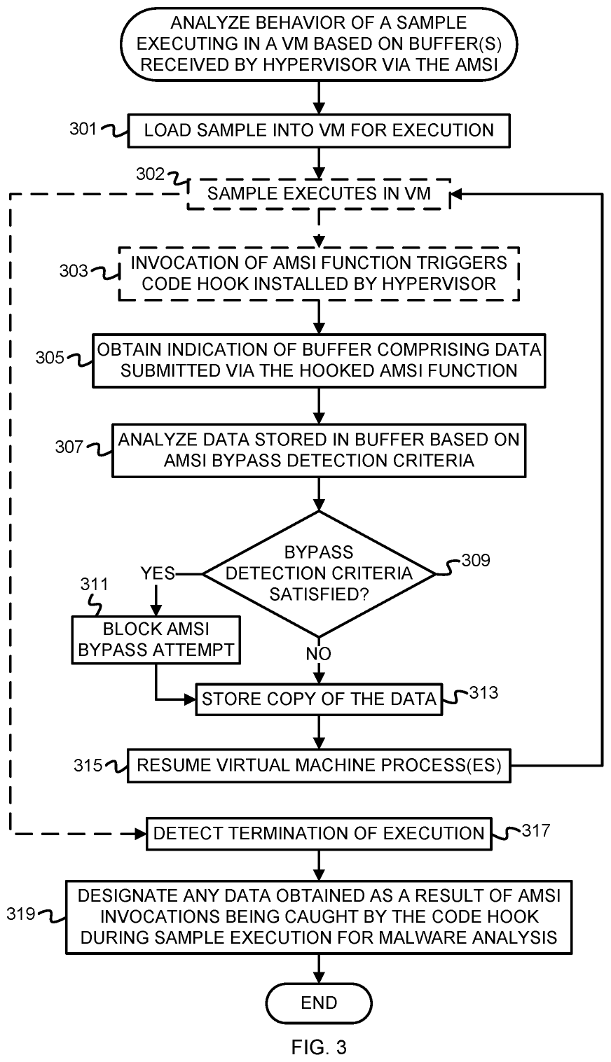

FIGS. 2 and 3 depict example operations for hypervisor-based monitoring of samples executing in a virtual machine via AMSI interception with VMI. The example operations are described with reference to a hypervisor-based AMSI event monitoring service (hereinafter “the service”) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for instrumenting the AMSI for interception of submission of content via the AMSI by the hypervisor. At block 201, the service instantiates a virtual machine. The instantiated virtual machine has applications and services running thereon that have the AMSI feature integrated (i.e., is a Windows virtual machine) such that compatible applications and services can submit data for analysis via the AMSI once AMSI is enabled. AMSI can be enabled via registration of an AMSI provider for the virtual machine, which triggers loading of the AMSI DLL (i.e., amsi.dll) in the virtual machine.

At block 203, the service inserts a code hook(s) into a target function(s) of the AMSI. The service hooks into one or more target functions of the AMSI to intercept AMSI function invocations. The service inserts at least a first code hook into the AMSI DLL, amsi.dll, to hook into the function AmsiScanBuffer. Invocation of this function (and any other hooked target functions) after loading the AMSI DLL will thus trigger the code hook and redirect execution to the service.

At block 205, a dummy AMSI provider is registered for the virtual machine to enable AMSI for the virtual machine. The dummy AMSI provider does not implement malware scanning or detection logic but allows for AMSI to be enabled for the virtual machine. The dummy AMSI provider is a dummy DLL. For instance, the dummy DLL may include method stubs in place of implementations of the functions of the AMSI provider. The dummy DLL may comprise the functionality to register itself as an AMSI provider, such as via registration of itself as a Component Object Model (COM) object or manually setting the appropriate registry keys associated with AMSI provider registration. In other examples, the service may assume administrator privileges for a command-line shell (e.g., the PowerShell interface) to create a session associated with the virtual machine and execute one or more commands for AMSI provider registration.

FIG. 3 is a flowchart of example operations for analyzing behavior of a sample executing in a virtual machine based on a buffer(s) received by the hypervisor via the AMSI. The example operations assume that a virtual machine has been instantiated and the service has hooked into the AMSI of the virtual machine as described in reference to FIG. 2. Blocks 302 and 303 are depicted with dashed lines to indicate that the corresponding example operations occur at the virtual machine rather than at the hypervisor.

At block 301, the service loads a sample into the virtual machine for execution. The sample may be a script, a macro, a file, etc. The sample is loaded into the virtual machine for execution by an AMSI-enabled application/service of the virtual machine, which may be a Windows component having AMSI integrated therein (e.g., Windows PowerShell, VBScript, Windows Script Host, etc.).

At block 302, the sample executes in the virtual machine. Block 302 is depicted as connected to blocks 303 and 317 with dashed lines. This is to represent that either of the corresponding example operations can occur during or after execution of the sample. Flow may continue to block 303 if a hooked AMSI function is invoked during execution of the sample. Flow may continue to block 317 if execution of the sample terminates.

At block 303, invocation of an AMSI function triggers the code hook installed by the hypervisor via the service. The application/service executing the sample can call an AMSI function that has been hooked by the service as described in reference to FIG. 2 to submit a buffer comprising data for a malware scan (i.e., the AmsiScanBuffer function). Invocation of this function triggers the code hook, and the service intercepts the AMSI function call. The virtual machine or at least a process(es) associated with execution of the sample is also paused/suspended as a result of the AMSI invocation interception by the service.

At block 305, the service obtains an indication of the buffer comprising data that was submitted for scanning via the hooked AMSI function. Parameter values of the function AmsiScanBuffer comprise a pointer to the buffer, the length of data to be read from the buffer for analysis, and a name associated with the data being scanned. The service obtains this information about the data being scanned when the function call is intercepted and is thus able to read the data to be scanned from memory of the host system.

At block 307, the service analyzes the data stored in the buffer based on one or more AMSI bypass detection criteria. The service has been configured with one or more criteria for detecting AMSI bypass attempts based on analysis of data stored in buffers submitted for scanning via the AMSI. The criteria may be, for instance, one or more keywords that are indicative of an attempt to bypass AMSI by a malicious sample. The criteria may be represented with lower-level semantics/features that can be identified based on direct access to memory or may be represented with higher-level semantics to which the lower-level semantics/features that are identified can be mapped. Keywords may correspond to functions names, variables, or sequences/combinations thereof that have been previously identified (e.g., based on prior testing and/or observation) as most likely called by malicious samples, such as keywords indicative of patching, disabling, or preventing load of the AMSI DLL. An example is a call to a function to load the AMSI DLL that returns a handle for the AMSI DLL (e.g., LoadLibraryA (amsi.dll)) and a subsequent call to GetProcAddress that specifies the returned handle for the AMSI DLL. Invocation of these functions is thus indicative that the sample is malicious. Alternatively, or in addition, the keywords can include keywords indicating that a sample has tampered with (e.g., has patched) a component(s) that supports AMSI functionality, such as the AMSI provider or the class System. Management.Automation.AmsiUtils. As an example, the criteria can comprise a keyword(s) indicating that the variable amsiInitFailed of this class has been set to true.

At block 309, the service determines if any of the AMSI bypass detection criteria were satisfied as a result of analyzing the data stored in the buffer. If at least a first criterion for detecting an AMSI bypass attempt was satisfied, operations continue at block 311. Otherwise, if none of the criteria were satisfied and thus no AMSI bypass attempt is detected, operations continue at block 313.

At block 311, the service blocks the AMSI bypass attempt by the sample. The service can communicate a command to the virtual machine to block execution of the line(s) of code corresponding to the AMSI bypass, which may be communicated after or as part of a communication(s) to resume the process(es) of the virtual machine that was/were paused or suspended. The sample may comprise additional program code, which may be malicious, that would be executed after bypassing the AMSI. Blocking the AMSI bypass and resuming execution of the sample allows for the behavior associated with this additional program code to be observed via subsequent AMSI invocations and buffer submissions. Malicious behavior that would otherwise go undetected as a result of the AMSI bypass can thus be identified.

At block 313, the service stores a copy of the data that were analyzed. The service can copy the data stored in the buffer that were submitted for scanning via the AMSI and store the copy of the data locally so the data are available for subsequent and/or additional analysis, such as malware analysis beyond AMSI bypass detection.

At block 315, the service resumes the process(es) of the virtual machine that was/were paused or suspended that at least comprises the process(es) associated with the sample. The service instructs the virtual machine (e.g., via a command(s)) to resume or to resume the paused/suspended process(es) to allow the sample to continue executing. If an AMSI bypass was blocked at block 311, the service may have resumed the process(es) as part of blocking the AMSI bypass before resuming execution of the sample.

At block 317, the service detects termination of execution of the sample. For example, the service may determine that a process(es) corresponding to execution of the sample has terminated based on a change in the process state.

At block 319, the service designates any data obtained as a result of AMSI invocations being caught by the code hook during execution of the sample for malware analysis. The data copied from the buffer(s) submitted via the AMSI that the service obtained via interception of the buffer submission (if any) can be designated for further malware analysis, such as to determine if any malicious behavior by the sample was observed after blocking an AMSI bypass. The service may designate the data for malware analysis by forwarding the data to a local malware analyzer or to an external service (i.e., that executes on another host system) that performs malware analysis.

### Variations

FIGS. 1-3 describe interception of AmsiScanBuffer function calls for analysis of whether a sample is attempting to bypass the AMSI or is otherwise malicious based on data obtained from the function call interceptions. In implementations, other functions of the AMSI can be hooked into as similarly described above. Data obtained from interception of these AMSI functions invoked by applications/services of a virtual machine can also be analyzed outside of the virtual machine at the level of the hypervisor to inform identification of malicious behavior by samples being analyzed.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

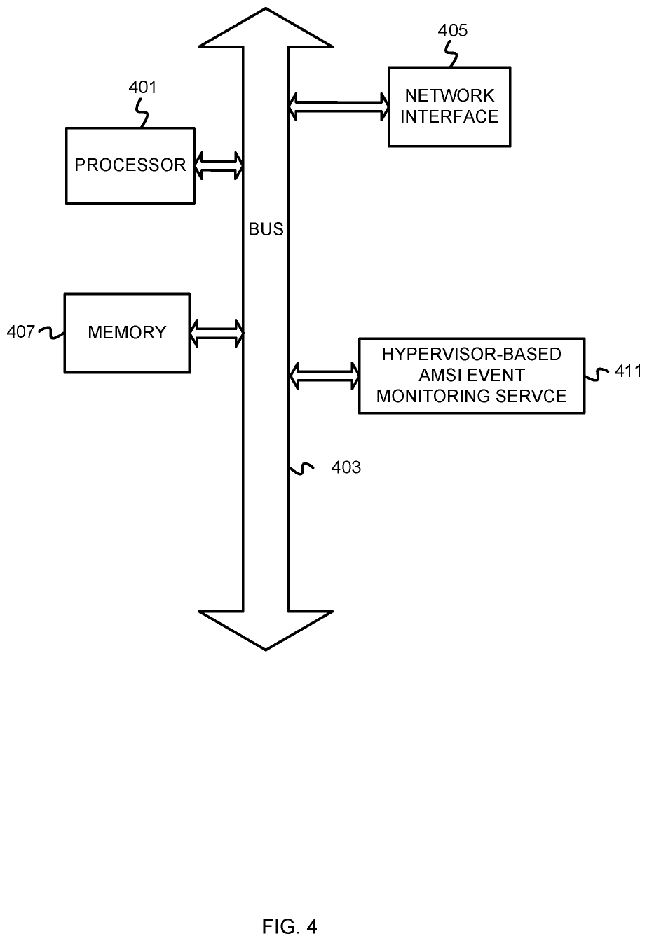

FIG. 4 depicts an example computer system with a hypervisor-based AMSI event monitoring service. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes hypervisor-based AMSI event monitoring service 411. The hypervisor-based AMSI event monitoring service 411 detects AMSI bypass attempts by samples executing in a corresponding virtual machine via VMI. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

1. A method comprising:
executing a software sample in a virtual machine, wherein a hypervisor created the virtual machine;
based on invocation of a first function of an antimalware scan interface (AMSI) by an application or service of the virtual machine that executes the software sample, obtaining, by the hypervisor, an indication of a buffer comprising data submitted to the AMSI by the application or service;
analyzing the data stored in the buffer based on one or more criteria for detecting attempts to bypass the AMSI;
based on determining that a subset of the data satisfies a first of the one or more criteria, detecting an attempt by the software sample to bypass the AMSI; and
blocking the attempt by the software sample to bypass the AMSI.

2. The method of claim 1, wherein analyzing the data stored in the buffer comprises determining if the data stored in the buffer comprise one or more keywords that are indicative of AMSI bypass.

3. The method of claim 2 wherein determining that a subset of the data satisfies the one or more criteria comprises determining that the data stored in the buffer comprise a first of the one or more keywords.

4. The method of claim 2, wherein the one or more keywords comprise at least one of one or more function call names and an indication of a dynamic link library (DLL) associated with the AMSI.

5. The method of claim 1 further comprising resuming execution of the software sample after blocking the attempt to bypass the AMSI by the software sample.

6. The method of claim 1 further comprising registering a dummy AMSI provider in the virtual machine.

7. The method of claim 6, wherein the dummy AMSI provider comprises a DLL that does not implement malware detection, wherein registering the dummy AMSI provider enables the AMSI for the virtual machine.

8. The method of claim 1 further comprising inserting a code hook into the first function, wherein invocation of the first function triggers the code hook, wherein the hypervisor obtaining the indication of the buffer is based on the code hook being triggered.

9. The method of claim 1 further comprising designating the data stored in the buffer for malware analysis.

10. One or more non-transitory machine-readable media having program code stored thereon, the program code comprising instructions to:
load a software sample into a virtual machine for execution, wherein a hypervisor created the virtual machine;
based on invocation of a first function of an antimalware scan interface (AMSI) by an application or service running in the virtual machine during execution of the software sample, obtain, by the hypervisor, an indication of a buffer comprising data submitted to the AMSI by the application or service;
determine whether the data stored in the buffer satisfy one or more criteria for detecting attempts to bypass the AMSI;
based on a determination that a subset of the data satisfies a first of the one or more criteria, detect an attempt by the software sample to bypass the AMSI; and
block the attempt by the software sample to bypass the AMSI.

11. The non-transitory machine-readable media of claim 10, wherein the program code further comprises instructions to register a dummy AMSI provider in the virtual machine, wherein registration of the dummy AMSI provider enables AMSI for the virtual machine.

12. The non-transitory machine-readable media of claim 11, wherein the instructions to register the dummy AMSI provider comprise instructions to register a dummy dynamic link library (DLL).

13. The non-transitory machine-readable media of claim 10, wherein the instructions to determine whether the data satisfy the one or more criteria comprise instructions to determine whether the data comprise one or more keywords that are indicative of AMSI bypass, and wherein the instructions to determine that the subset of the data satisfy the criteria comprise instructions to determine that the subset of the data comprise a first of the one or more keywords.

14. The non-transitory machine-readable media of claim 13, wherein the one or more keywords comprise at least one of one or more function call names and an indication of a DLL associated with the AMSI.

15. The non-transitory machine-readable media of claim 10, wherein the program code further comprises instructions to hook into the first function of the AMSI, wherein the invocation of the first function by the application or the service running in the virtual machine triggers redirection of execution to the hypervisor, and wherein obtaining the indication of the buffer is based on invocation of the first function.

16. An apparatus comprising:
a processor; and
a machine-readable medium having instructions stored thereon that are executable by the processor to cause the apparatus to,
load a software sample in a virtual machine for execution, wherein a hypervisor created the virtual machine;
based on invocation of a first function of an antimalware scan interface (AMSI) by an application or service of the virtual machine that executes the software sample, obtain, by the hypervisor, an indication of a buffer comprising data submitted to the AMSI by the application or service;
analyze the data stored in the buffer to determine if the data satisfy one or more criteria for detecting attempts to bypass the AMSI;
based on a determination that a subset of the data satisfies a first of the one or more criteria, detect an attempt by the software sample to bypass the AMSI; and
block the attempt by the software sample to bypass the AMSI.

17. The apparatus of claim 16,
wherein the instructions executable by the processor to cause the apparatus to determine if the data satisfy the one or more criteria comprise instructions to determine if the data in the buffer indicate a first of one or more keywords, and
wherein the instructions executable by the processor to cause the apparatus to detect the attempt by the software sample to bypass the AMSI comprise instructions executable by the processor to cause the apparatus to determine that the data in the buffer indicate a first of the one or more keywords.

18. The apparatus of claim 17, wherein the one or more keywords comprise at least one of one or more function call names and an indication of a dynamic link library (DLL) associated with the AMSI.

19. The apparatus of claim 16 further comprising instructions executable by the processor to cause the apparatus to resume execution of the software sample in the virtual machine based on blocking the attempt to bypass the AMSI.

20. The apparatus of claim 16 further comprising instructions executable by the processor to cause the apparatus to register a dummy AMSI provider in the virtual machine,
wherein registration of the dummy AMSI provider enables AMSI for the virtual machine,
wherein the dummy AMSI provider comprises a dummy DLL.
